(19) United States
(12) Patent Application Publication
(10) Pub. No.: US 2017/0308971 A1
(43) Pub. Date: Oct. 26, 2017

(54) METHOD OF ORGANIZATION OF PASSENGER TRAVEL IN A TRANSPORT SYSTEM, ASSOCIATED COMPUTER PROGRAM PRODUCT AND SYSTEM OF ORGANIZATION

(71) Applicant: ALSTOM Transport Technologies, Saint-Ouen (FR)

(72) Inventor: Stephane BOURLAND, NEUILLY S/SEINE (FR)

(21) Appl. No.: 15/489,470

(22) Filed: Apr. 17, 2017

(30) Foreign Application Priority Data
Apr. 25, 2016 (FR) 1653643

(51) Int. Cl. G06Q 50/14; G06Q 10/02

(52) U.S. Cl. CPC G06Q 50/14; G06Q 10/02

(57) ABSTRACT

This method for organizing passenger travel is implemented by a computer system and includes the following steps: collecting (110) computer data relative to each passenger's wishes in the organization of his travel; processing (120) the collected computer data to identify similar wishes by different passengers and to create a plurality of passenger groups, such that each passenger in each group has at least one wish similar to a wish of another passenger in this group; and assigning (140) a seat in one of the vehicles to each passenger based on the or each group to which he belongs.

### FIELD OF THE INVENTION

The present invention relates to a method of organization of passenger travel in a transport system.

The present invention also relates to an associated computer program product and system of organization.

Such a transport system comprises a plurality of vehicles making it possible to transport passengers. Each vehicle is in particular a rail vehicle such as a train making regular connections between different locations.

### BACKGROUND OF THE INVENTION

In general, to organize travel by train, a passenger must make a prior reservation by choosing the departure location, the arrival location, the departure date and time, the travel class, etc.

Such a reservation is generally managed by a computer reservation system that then assigns a seat to the passenger based on the number of seats available on the selected train.

When the selected train is full, the system can offer the passenger another train making the same trip or a similar trip on another schedule.

Reservation systems also exist making it possible to account for certain other desires by the passenger during the reservation process. These desires in particular comprise passenger preferences relative to the location on board the train or other services on board the train, for example an onboard meal.

In this case, the reservation system analyzes whether the passengers wishes can be fulfilled, in particular by verifying the availability of the desired location, the requested services, etc.

When these wishes cannot be fulfilled, the reservation system informs the passenger.

One can then see that such a reservation system is not flexible enough and does not make it possible to fulfill the passengers wishes in a satisfactory manner. Furthermore, organizing the travel of a large number of passengers with different wishes using such a system is relatively complex.

### SUMMARY OF THE INVENTION

The present invention aims to propose a method of organization of passenger travel making it possible to greatly facilitate the organization of such travel in a transport system while best fulfilling passengers' wishes.

To that end, the invention relates to a method of organization of passenger travel in a transport system including a plurality of vehicles;
the method being implemented by a computer system and including the following steps:
collecting computer data relative to each passengers wishes in the organization of his travel;
processing the collected computer data to identify similar wishes by different passengers and to create a plurality of passenger groups, such that each passenger in each group has at least one wish similar to a wish of another passenger in this group;
assigning a seat in one of the vehicles to each passenger based on the or each group to which he belongs.

According to other advantageous aspects of the invention, the organization method comprises one or more of the following features, considered alone or according to all technically possible combinations:
each wish corresponds to one of the elements chosen from the group consisting of: departure location, arrival location, departure date, arrival date, departure time, arrival time, maximum travel time, travel class within the vehicle, location within the vehicle, atmosphere within the vehicle, proximity of a passenger or a group of passengers, specific service need, pre-departure service, service on board the vehicle, post-arrival service, number of bags, weight of each bag, maximum fare, permission for the passengers personal information to be downloaded from a social network, flexibility of one or more of the aforementioned elements;
each wish is associated with a type selected from the group consisting of: mandatory type, preference type, and proposal type;
the assignment of a seat to each passenger is done in accordance with all of the mandatory wishes expressed by this passenger;
a communication step comprising sending to a passenger a proposed change to one or several of his mandatory wishes;
a communication step comprising sending a passengers proposal type wishes to the other passengers or a proposal at the initiative of a manager of the computer system based on passengers' wishes and profiles;
a step for determining a new interior layout configuration of a vehicle making it possible to fulfill more wishes, in particular of the preference or proposal type, by each passenger in at least one group of passengers; and
each vehicle is a rail vehicle.

The invention also relates to a computer program product including software instructions which, when executed by computer equipment, carry out a method as defined above.

The invention also relates to a system of organization of passenger travel in a transport system including a plurality of vehicles. The organization system includes at least one communication unit able to collect computer data relative to wishes of each passenger for the organization of his travel; and a processing unit able to collect computer data to identify similar wishes by different passengers and to create a plurality of passenger groups, such that each passenger in each group has at least one wish similar to a wish of another passenger in this group; and to assign a seat in one of the vehicles to each passenger based on the or each group to which he belongs.

### BRIEF DESCRIPTION OF THE DRAWINGS

The features and advantages of the invention will be better understood upon reading the following description, provided solely as a non-limiting example, and done in reference to the appended drawings, in which:

FIG. 1 is a schematic illustration of an organization system according to the invention; and

FIG. 2 is a block diagram of an organization method carried out by the system of FIG. 1.

### DETAILED DESCRIPTION OF THE INVENTION

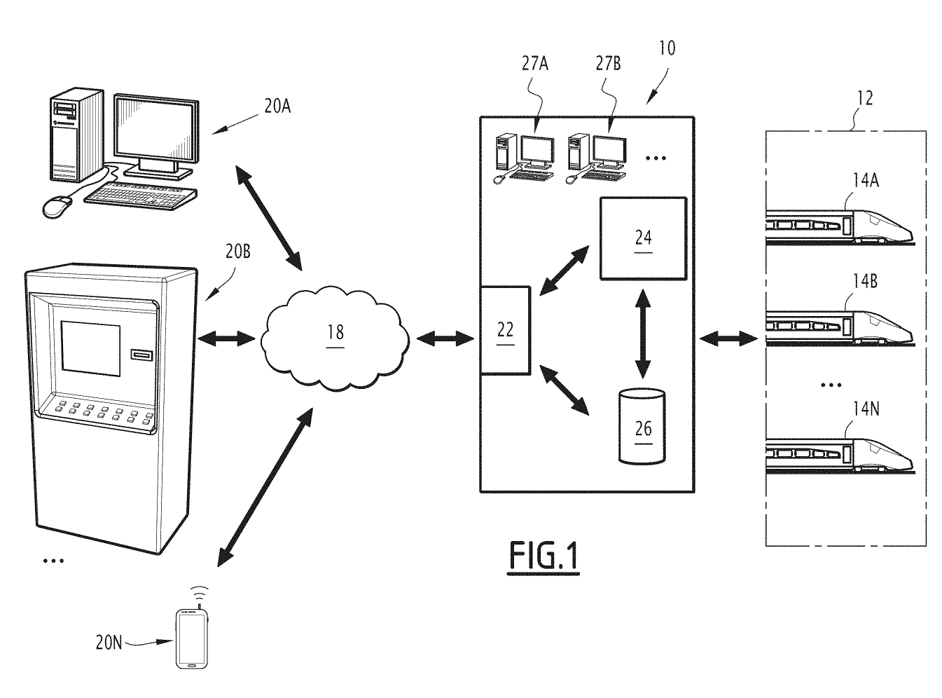

FIG. 1 shows a system 10 for organizing the travel of passengers.

This organization system 10 makes it possible to organize the travel of a large number, for example greater than 100, advantageously greater than 300, of passengers in a transport system 12.

The transport system 12 comprises a plurality of vehicles making it possible to transport the passengers.

Each vehicle is for example a rail vehicle, in particular a train 14A to 14N shown in FIG. 1. Such a train 14A to 14N for example provides regular connections between different locations.

However, it must be understood that the invention remains applicable to any other type of vehicle, such as coaches, airplanes, etc.

Furthermore, according to the invention, the transport system 12 may comprise vehicles of different types, for example trains and coaches.

Each train 14A to 14N includes a plurality of cars. Each car comprises an interior layout in particular made up of a plurality of passenger seats, restrooms, luggage compartments, etc.

Each seat corresponds to a passengers location on the train.

Thus, hereinafter, “passengers seat on a train” refers to the passengers location on this train, and in particular the seat assigned to this passenger on the train. The places (seats, benches, stowable seats, ischiatic supports, etc.) are for example numbered and can be identified uniquely within the corresponding train.

Each passenger can then reserve a seat on board one of the trains 14A to 14N through a reservation process, as will be explained below.

The interior layout of at least one car of each train 14A to 14N may comprise a bar or any other point of sale or distribution for consumer products (reading materials, other services, etc.), in particular onboard food.

In a manner known in itself, the interior layouts of the different cars are made up of different areas based on a travel class assigned to each area.

According to one alternative embodiment, at least one train 14A to 14N has a configurable interior layout. Thus, such an interior layout can be modified for each trip by the corresponding train 14A to 14N, for example based on passengers' wishes, as will be explained below.

In particular, such a configurable layout makes it possible to modify the travel class of an area of a car, the number of seats, the orientation of the seats, the distance between the seats, etc.

To simplify the reading of the description below, it will be considered that all of the trains 14A to 14N are leaving on the same day and making similar trips. However, it must be understood that in general, the transport system 12 has a more complex structure and in particular includes vehicles traveling at different times and making different trips.

In particular, the train 14A for example makes a trip between a station A and a station B according to a predetermined schedule, for example leaving from station A at 17:52.

The train 14B makes the same trip as the train 14A, i.e., the trip between station A and station B, according to a different predetermined schedule, for example leaving from station A at 18:30.

Lastly, the train 14N makes a similar trip, i.e., a trip between station A or a station D close to station A and a station C close to station B, for example. The departure time of this train from station A or D is for example 19:00.

The organization system 10 is a computer system, such as one or more computers.

The organization system 10 is in particular connected to a global computer network 18, such as the Internet, allowing it to communicate with local passenger terminals 20A to 20N.

In particular, as illustrated in FIG. 1, the organization system includes a communication unit 22, a computer data processing unit 24, a computer database 26 and optionally one or several consoles 27A, 27B.

The communication unit 22 is for example a connection interface with the computer network 18. Such a connection interface in particular makes it possible to exchange computer data with the computer network 18.

The database 26 for example has a storage means able to store computer data from the communication unit 22 or the processing unit 24.

The processing unit 24 makes it possible to process computer data received via the communication unit 22 or stored in the database 26 to carry out at least certain steps of an organization method described in detail below.

The consoles 27A, 27B allow a manager or operator to intervene in the operation of the organization system 10.

Each passenger terminal 20A to 20N for example has a computer connected to the computer network 18 and able to implement suitable communication software for communicating with the organization system 10 via the communication network 18.

In the example embodiment of FIG. 1, the local terminal 20A is a computer for example installed in the passengers home, the local terminal 20B is a reservation terminal installed in a train station, and the local terminal 20N is a mobile smartphone.

The communication software for example has an application integrated at least partially into a social network.

Of course, other example embodiments of local communication terminals are also possible.

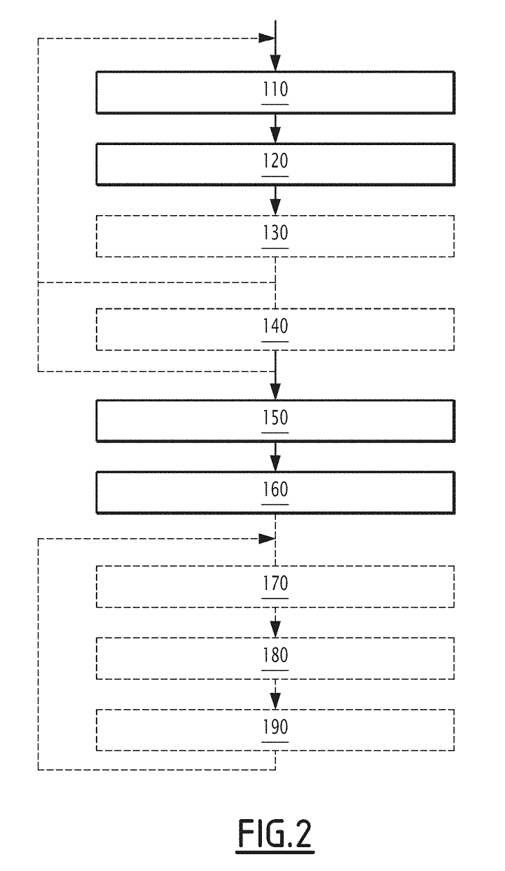

The organization method implemented by the organization system 10 will now be explained in reference to FIG. 2, showing a block diagram of its steps.

Initially, the departure date and the trips by all of the trains 14A to 14N are determined.

The initial step 110 of the organization method consists of collecting computer data relative to passengers' wishes for the organization of their travel with one of the trains 14A to 14N.

In particular, this step 110 is carried out when the software programs for communication with the organization system 10 of the terminals 20A to 20N give passengers access to the reservation process for their travel for the determined date.

The opening of the reservation process is for example scheduled automatically three months before the determined departure date.

In particular, during the reservation process, each passenger reserves this travel for the determined date by giving the corresponding communication software a certain number of wishes for the organization of his travel.

Each wish for example pertains to one of the elements chosen from the group comprising at least:
departure location;
arrival location;
departure date;
arrival date;
departure time;
arrival time;
maximum travel time;
travel class within the train;
location within the train;
atmosphere in the train (peaceful, family, etc.);
proximity (person(s), group, etc.);
specific service need (seat for a person with reduced mobility, suggestion by the passenger to a manager of the computer system, etc.);
pre-departure service;
service on board the train (meal);
post-arrival service;
number of bags;
weight of each bag;
maximum rate or selection from a rate table;
permission to download the passengers personal information from a social network;
flexibility with one or more of the aforementioned elements.

The specific service needs in particular comprise the suggestion by a passenger, to the operator, to create a group of passengers or an atmosphere within the train.

During the reservation process, the passenger also associates a type with each indicated wish. Each type is chosen from the group comprising:
mandatory type;
preference type; and
proposal type.

The mandatory wishes are for example chosen from a list of predetermined wishes and must be respected by the organization system 10.

Thus for instance, the passenger may indicate that his wishes relative to the departure location, the arrival location and the departure date are mandatory.

The preference wishes are for example chosen from a list of predetermined wishes and must preferably be respected by the organization system 10.

Thus for instance, the passenger may indicate that his wishes relative to the departure time and the travel class are preferences.

The proposal wishes are for example chosen from a list of predetermined wishes and must preferably be taken into account by the organization system 10.

Thus for instance, the passenger may indicate his wish to be placed on the train next to supporters of a sports team or next to a passenger X or several passengers Y and Z.

The passenger may also indicate his wish to have a means of transport allowing him to return to his final destination after arrival in the destination station or to have a particular service on board the train (for example, Internet access).

Many other examples of proposal-type wishes are also possible.

When the reservation process is complete, the corresponding communication software sends the wishes indicated by the passenger and the associated types to the organization system 10 via the computer network 18 in the form of computer data. The system then guarantees the passenger a service corresponding to the mandatory selections.

The communication unit 22 of the organization system 10 then receives all of the computer data sent by the communication software from the local terminals 20A to 20N of passengers having completed the reservation process.

The communication unit 22 then stores all of the received computer data in the database 26.

The following step 120 is carried out when the computer data relative to the wishes of a predetermined number of passengers has been collected by the organization system 10.

In other words, step 120 is carried out when a predetermined number of passengers have completed the reservation process.

This predetermined number for example corresponds to half of the total capacity of the trains 14A to 14N.

During this step 120, the processing unit 24 extract the corresponding computer data from the database 26, in particular to analyze all of the wishes sent by the passengers.

In particular, the processing unit 24 first identifies similar wishes from different passengers.

“Similar wishes” refer to identical wishes or close wishes according to a proximity criterion determined for each wish relative to one of the elements in the aforementioned list.

Thus for example, the wish indicating 17:52 as the departure time and the wish indicating 18:00 as the departure time are considered to be similar.

The wish by passenger Y to be seated next to passenger X and the wish by passenger X to be seated next to passenger Y are considered to be similar.

The wish by a passenger to be seated next to sports fans and the wish by another passenger to be seated next to supporters of a sports team are also considered to be similar. Conversely, the wish by one passenger to be seated next to supporters of a sports team and the wish by another passenger to be seated next to supporters of an opposing sports team are not considered to be similar.

The wish by a passenger to have a means of transport to his final destination after arrival in the station and the wish by another passenger to have a means of transport to a location close to this first passengers final destination are considered to be similar.

The proximity criteria of the wishes can then be established for each trip and each departure date independently. Thus for instance, two sports teams are considered opposing only when they are playing against one another on the departure date.

After having identified similar wishes, the processing unit 24 establishes groups of passengers having similar wishes.

In particular, a passenger may be assigned to several groups, for example, a group of passengers all wishing to leave with train 14A, i.e., at 17:52, and a group of passengers all supporting a sports team and wishing to be seated together.

According to one example embodiment, the organization method further comprises an optional step 130 for communicating with the passengers, carried out by the processing unit 24.

In particular, during this step, the processing unit 24 generates proposals based on the capacities of the trains 14A to 14N and based on the wishes indicated by the passengers.

The proposals are for example generated based on passengers' personal data, downloaded from a social network, when the passengers have given permission for such downloading.

Advantageously, the processing unit 24 also generates additional proposals based on suggestions made by the passengers (in the form of wishes corresponding to specific service needs) and selected by the manager of the computer system, for example depending on the number of identical suggestions received.

In particular, during this step, the processing unit 24 sends proposals to the passengers to modify at least some of their wishes or the type of these wishes and proposes opportunities with new possible wishes.

To that end, the processing unit 24 analyzes all of the sent wishes and identifies possibilities for optimization using optimization methods that are known in themselves.

Each optimization method for example makes it possible to best fulfill the wishes of each passenger, or at least a group of passengers, or to optimize the filling of the trains 14A to 14N.

Thus, for example, the processing unit 24 can send a passenger a proposal to change one of his wishes from mandatory to another type in return for a perk or remuneration.

In this case, if the passengers wish for example consisted of a mandatory wish to leave with train 14A, i.e., at 17:52, the processing unit 24 can propose to this passenger to leave with train 14B, i.e., at 18:30, in return for a perk or remuneration, when for example the demand regarding train 14A is high, but train 14B is relatively empty.

According to still another example embodiment, during this step 130, the processing unit 24 sends all or at least some of the passengers a proposal corresponding to a proposal-type wish sent by a passenger during step 110.

Thus for example, when a passenger has sent a proposal-type wish consisting of finding a means of transport allowing him to reach his final destination, the processing unit 24 can send a proposal to all of the other passengers with similar wishes to share a taxi with this passenger, for instance.

Another proposal may be sent to passenger Z after the wish by passenger X to be seated next to passenger Z. In this case, the processing unit 24 proposes to passenger Z to confirm his wish to be seated next to X.

The passengers then receive the proposals sent by the processing unit 24 and accept or reject them. The responses to these proposals are next sent in the form of computer data and the collection 110 and processing 120 steps for this data are then carried out again.

During this step, the organization system 10 can be managed at least partially by a manager or operator who can use the consoles 27A, 27B in order to analyze the data regarding the passengers' wishes and profiles in order to offer them complementary or relevant wishes and services, if applicable.

The following step 140 is optional and is carried out when the interior layout of at least one car of one of the trains 14A to 14N is configurable.

In this case, the processing unit 24 determines a new configuration of the interior layout of this car for example making it possible to best fulfill the wishes of the passengers or to increase the capacity of this car when, for example, the demand on the corresponding train 14A to 14N is particularly high.

Thus, for example, when the interior layout of the car including the bar is configurable and when the demand on the corresponding train is particularly high, the processing unit 24 can determine a new configuration of this car in which the layout of the bar is replaced by additional seats for passengers. In this case, the bar is for example replaced by a mobile catering service on the train and the collection 110 and processing 120 steps are then carried out again.

The following step 150 is carried out separately for each of the trains 14A to 14N, for example N minutes before the corresponding train 14A to 14N departs.

The number N is preferably comprised between 10 and 60, and is for example equal to 20.

According to another alternative embodiment, the number N is greater than 60, preferably greater than 120 and less than or equal to 1440. In other words, when N is equal to 1440, the step 150 is carried out 24 hours before the corresponding train 14A to 14N departs.

During this step 150, the processing unit 24 assigns seats to each passenger on the corresponding train.

In particular, the processing unit 24 assigns a seat to a passenger according to the or each group associated with this passenger during step 120 and according to this passengers wishes.

This assignment is done in accordance with the passengers mandatory wishes and respecting the preference and proposal wishes as much as possible.

Thus, for example, when a passenger is associated with a group of supporters of a sports team, his seat will be located near the latter when possible in light of his other wishes, wishes of the other passengers, and the capacity of the corresponding train.

During the following step 160, the communication unit 22 communicates the seat number assigned to each of the passengers.

Thus, the communication unit 22 sends computer data corresponding to the assigned seat via the computer network 18. In this case, the passengers receive this information via one of the local terminals 20A to 20N, preferably via the portable smart phone 20N.

According to one alternative embodiment, the passengers receive this information via terminals provided to that end in the departure station or via any other suitable technical means, for example consoles in the vehicle itself.

Additionally, during this step, the communication unit 22 further sends additional information relative to the trip or access to the assigned seat. The communication unit 22 for example sends an itinerary to be followed to access the assigned seat optimally. The itinerary for example corresponds to a map of the train (i.e., the cars and the access doors to the different cars) and the path to access the assigned seat.

The following steps 170 to 190 are optionally carried out separately for each of the trains 14A to 14N, after the departure of this train.

These steps 170 to 190 are similar to steps 110 to 130 carried out before the corresponding train departs.

Thus, during step 170, the communication unit 22 collects computer data relative to wishes expressed by passengers on board, for example via a local terminal, such as a smartphone 20N.

These wishes are in particular of the proposal type and for example relate to a change of seat, atmosphere, etc., or the possibility of reaching the final destination after the train has arrived at the destination station.

During the following step 180, the processing unit 24 processes all of the computer data collected during the trip, in particular to identify similar wishes.

Then, like during step 120, the processing unit 24 forms groups of passengers having similar wishes.

Thus, for example, during this step, all of the passengers wishing to reach a location D after the train arrives at the destination station are associated with a same group.

During the same step, the processing unit 24 also generates proposals for at least some of the passengers to modify at least some of their wishes.

During the following step 190, the communication unit 22 sends all of the formed groups as well as the generated proposals to the relevant passengers.

These passengers accept or reject the received proposals by sending the corresponding responses, and optionally other wishes, to the organization system 10. The collection 170 and analysis 180 steps are then carried out again.

Advantageously, after the train arrives at the destination station, the method comprises a step for collecting passengers' opinions about the trip. During this step, the communication unit 22 for example sends each passenger a form to collect passenger opinions.

Alternatively, during step 170, the communication unit 22 collects computer data relative to the estimated arrival time of the train, for example sent by a central rail traffic management unit. In this alternative, during the following step 180, if the train is late, the processing unit 24 processes all of the collected computer data and generates proposals for at least some of the passengers. These proposals are in particular intended for passengers having a transfer, and relate to changes to at least some of their wishes, for example a new proposed seat on the next train.

Of course, many other example embodiments of the present invention are also possible.

One can then see that the present invention has a number of advantages.

Indeed, the organization method and system according to the invention make it possible to assign seats to passengers based on their wishes.

This in particular allows an effective management of different atmospheres within a vehicle or a group of cars of a vehicle or a car of a vehicle by grouping passengers together who have common interests.

The capacity of the vehicle and the location of the passengers can then be adapted to best fulfill the passengers' wishes.

Each passenger can thus participate in creating each atmosphere to make his trip more interesting.

Furthermore, different services can be offered before the vehicle departs, during the trip or after its arrival. These proposals can account for passengers' profiles and habits.

Furthermore, the invention makes it possible to optimize the filling of the vehicles that are part of a same transport system. In particular, the invention makes seat assignments flexible not only in a vehicle, but also in several vehicles for example making similar trips with close schedules.

Lastly, the invention makes it possible to store all of the data relative to the passengers' wishes. This data can next be used to improve the provided service and enable an ongoing dialogue between the operator of the transport system in question and the passengers.

1. A method of organization of passenger travel in a transport system including a plurality of vehicles;
the method being implemented by a computer system and including the following steps:
collecting computer data relative to each passenger's wishes in the organization of his travel;
processing the collected computer data to identify similar wishes by different passengers and to create a plurality of passenger groups, such that each passenger in each group has at least one wish similar to a wish of another passenger in this group;
assigning a seat in one of the vehicles to each passenger based on the or each group to which he belongs.

2. The method according to claim 1, wherein each wish corresponds to one of the elements chosen from the group consisting of:
departure location;
arrival location;
departure date;
arrival date;
departure time;
arrival time;
maximum travel time;
travel class within the train;
location within the train;
atmosphere within the train;
proximity of a passenger or group of passengers;
specific service need;
pre-departure service;
service on board the vehicle;
post-arrival service;
number of bags;
weight of each bag;
maximum fare;
permission to download the passenger's personal information from a social network;
flexibility with one or more of the aforementioned elements.

3. The method according to claim 1, wherein each wish is associated with a type selected from the group consisting of:
mandatory type;
preference type; and
proposal type.

4. The method according to claim 3, wherein the assignment of a seat to each passenger is done in accordance with all of the mandatory wishes expressed by this passenger.

5. The method according to claim 3, further comprising a communication step comprising sending to a passenger a proposed change to one or several of his mandatory wishes.

6. The method according to claim 3, further comprising a communication step comprising sending a passenger's proposal type wishes to the other passengers or a proposal at the initiative of a manager of the computer system based on passengers' wishes and profiles.

7. The method according to claim 3, further comprising a step for determining a new interior layout configuration of a vehicle making it possible to fulfill more wishes, in particular of the preference or proposal type, by each passenger in at least one group of passengers.

8. The method according to claim 1, wherein each vehicle is a rail vehicle.

9. A non-transitory computer readable medium on which is stored a program including instructions which, when executed by computer equipment, carry out the method according to claim 1.

10. A system for organizing of passenger travel in a transport system including a plurality of vehicles;
the organization system including:
a communication unit able to collect computer data relative to each passenger's wishes in the organization of his travel; and
a processing unit able to:
process the collected computer data to identify similar wishes by different passengers and to create a plurality of passenger groups, such that each passenger in each group has at least one wish similar to a wish of another passenger in this group;
assign a seat in one of the vehicles to each passenger based on the or each group to which he belongs.

11. The method according to claim 2, wherein each wish is associated with a type selected from the group consisting of:
mandatory type;
preference type; and
proposal type.

12. A non-transitory computer readable medium on which is stored a program including instructions which, when executed by computer equipment, carry out the method according to claim 2.

13. A non-transitory computer readable medium on which is stored a program including instructions which, when executed by computer equipment, carry out the method according to claim 3.

14. A non-transitory computer readable medium on which is stored a program including instructions which, when executed by computer equipment, carry out the method according to claim 4.

15. A non-transitory computer readable medium on which is stored a program including instructions which, when executed by computer equipment, carry out the method according to claim 5.

16. A non-transitory computer readable medium on which is stored a program including instructions which, when executed by computer equipment, carry out the method according to claim 6.

17. A non-transitory computer readable medium on which is stored a program including instructions which, when executed by computer equipment, carry out the method according to claim 7.

18. A non-transitory computer readable medium on which is stored a program including instructions which, when executed by computer equipment, carry out the method according to claim 8.
